(19) United States
(12) Patent Application Publication
(10) Pub. No.: US 2026/0356118 A1
(43) Pub. Date: Nov. 12, 2026

(54) MULTI-FUNCTIONAL STICKY PENCIL CASE

(71) Applicant: SOOHYEON JANG, SEOUL (KR)

(72) Inventor: SOOHYEON JANG, SEOUL (KR)

(21) Appl. No.: 19/245,791

(22) Filed: Jun. 23, 2025

(30) Foreign Application Priority Data
May 9, 2025 (KR) 10-2025-0060187

(51) Int. Cl. B43K 23/008; B43K 29/06; G06F 3/0354

(52) U.S. Cl. CPC B43K 23/008; B43K 29/06; G06F 3/03545

(57) ABSTRACT

A multi-functional pencil case includes a tubular case body having a slide guide formed along a longitudinal direction thereof, wherein a pencil is inserted and fixed at one end of the tubular case body, a slide stopper movably engaged with the slide guide and configured to move according to the length of the pencil, a slot-forming plate provided on an outer surface of the tubular case body, and having a straight slot in which a flat ruler is received and fixed, and an assembly tube detachably coupled to the other end of the tubular case body, and provided with a pencil sharpener.

### CROSS-REFERENCE TO RELATED PATENT APPLICATION

This application is based on and claims priority under 35 U.S.C. § 119(a) of Korean Patent Application No. 10-2025-0060187, filed on May 9, 2025, in the Korean Intellectual Property Office, the disclosure of which is incorporated by reference herein in its entirety.

### BACKGROUND OF THE INVENTION

### 1. Field of the Invention

The present invention relates to a multi-functional pencil case, and more particularly, to a multi-functional pencil case that enhances the usability of shortened pencils or so-called “stubby pencils,” while integrating various supplementary writing and learning tools to improve portability and convenience of use.

### 2. Description of Related Art

Writing instruments have continuously evolved as essential tools for recording, transmitting, and expressing knowledge, in tandem with the advancement of human civilization. In particular, the pencil is one of the most universally used writing instruments, having a wide user base ranging from students to professionals.

However, as a pencil is used, its length gradually decreases, and when it becomes shortened below a certain length—commonly referred to as a “stubby pencil” it generally becomes difficult to grasp properly, resulting in decreased writing performance and eventual disposal. This not only leads to a waste of resources but also imposes an economic burden on users who must continuously purchase new pencils.

To increase the usability of stubby pencils, various pencil holders and extension tools have been developed. However, these tools are generally limited to the function of merely extending the length of the pencil and thus have inherent limitations in terms of portability and versatility. For example, conventional pencil holders only serve to hold the pencil in place, and do not eliminate the inconvenience of having to carry other school supplies separately, such as rulers, erasers, and pencil sharpeners, which are often needed during writing.

In addition, as the use of digital devices continues to increase in modern learning and work environments, the demand for touch pens to operate touchscreen interfaces is also growing. However, carrying both analog writing instruments and digital input tools such as touch pens is cumbersome, and switching between these tools as needed carries the risk of misplacement or loss.

Moreover, students frequently use pencils, rulers, and erasers, particularly when studying subjects such as mathematics or science. The task of retrieving each tool individually from a pencil case may interrupt the learning flow and reduce concentration. Furthermore, managing each school supply separately increases the likelihood of loss.

Accordingly, there has been a growing demand for the development of a new type of writing instrument case that not only enables the effective reuse of stubby pencils but also integrates multiple essential supplementary tools for learning and writing into a single portable device, thereby maximizing convenience, portability, economic efficiency, and resource utilization.

Examples of the related art include Korean Patent Publication No. 10-2024-0077734.

### SUMMARY OF THE INVENTION

The present invention has been devised to solve the above-mentioned problems by providing a multi-functional pencil case that enables stable gripping and usage of shortened stubby pencils, while efficiently integrating various supplementary writing and learning tools—such as rulers, erasers, pencil sharpeners, and touch pens—into a single case, thereby maximizing convenience and portability, minimizing the risk of losing school supplies, and enhancing resource reuse and economic efficiency.

Another object of the present invention is to provide a sliding mechanism that allows the user to easily adjust and securely fix the exposed length of the pencil based on its remaining length.

A further object of the present invention is to provide a structure in which a ruler and an eraser can be detachably coupled to the main body of the case so that they can be readily used as needed.

Another object of the present invention is to provide a modular structure at the end of the case that not only incorporates a pencil sharpening function but also allows the storage and optional use of additional tools such as a touch pen.

Yet another object of the present invention is to provide a structure that optimizes the cross-sectional shape of the case body to offer excellent grip and enable the efficient arrangement of each functional component.

According to one embodiment of the present disclosure relates to a multi-functional pencil case. The multi-functional pencil case includes a tubular case body having a slide guide formed along a longitudinal direction thereof, wherein a pencil is inserted and fixed at one end of the tubular case body, a slide stopper movably engaged with the slide guide and configured to move according to the length of the pencil, a slot-forming plate provided on an outer surface of the tubular case body, and having a straight slot in which a flat ruler is received and fixed, and an assembly tube detachably coupled to the other end of the tubular case body, and provided with a pencil sharpener.

In one embodiment, the multi-functional pencil case may further include a touch pen configured to be inserted into the one end of the tubular case body in place of the pencil, and being removably stored and fixed in the assembly tube.

In one embodiment, the tubular case body may have a hollow hexagonal cross-section structure, and the slide guide and the slot-forming plate are positioned on opposite faces of a hexagonal structure.

In one embodiment, the assembly tube may include a case assembly portion having a hollow hexagonal cross-section structure configured to be assembled with the tubular case body and a pen receiving portion having a hollow circular cross-section structure configured to receive the touch pen, wherein the touch pen is partially inserted into the pen receiving portion such that a pen grip protrudes outward.

In one embodiment, the multi-functional pencil case may further include an eraser having a coupling plate that is detachably coupled to the straight slot at one end of the slot-forming plate.

In one embodiment, the slide stopper may have an H-shaped cross-section, with a middle portion formed in the shape of a flat plate, to be slidable along the slide guide of the tubular case body.

In one embodiment, a pull-out groove for extracting the flat ruler may be formed in a middle portion of the slot-forming plate.

According to the present invention, the multi-functional pencil case enables a stubby pencil—previously difficult to use due to its short length—to be inserted into the case body and fixed by the slide stopper, thereby providing a stable gripping and writing feel like that of a full-length pencil. This maximizes the utility of pencil resources, reduces waste, and contributes to both economic and environmental benefits. By integrating essential writing and learning tools into a single unified case, the internal space of a pencil case can be utilized more efficiently, or the pencil case itself may be replaced entirely, thereby maximizing portability and enabling users to quickly access necessary tools to improve learning and work efficiency.

In addition, the present invention provides a slot-forming plate on the outer surface of the case body for receiving a straight ruler and optionally allows for the additional coupling of an eraser. This eliminates the inconvenience of carrying frequently used supplementary tools separately for writing and studying and significantly reduces the risk of loss.

Furthermore, the present invention allows for convenient sharpening pencils at any time by providing an assembly tube with a built-in pencil sharpener coupled to the other end of the case body. The assembly tube may also store a touch pen internally, which can be attached to the case body in place of a pencil when needed. This enables smooth transition between analog writing environments and digital touch environments, while further enhancing portability.

In addition, the present invention allows for adjustment to an optimal state of use based on the remaining length of the pencil through movement of the slide stopper. As such, it can be effectively applied to stubby pencils of various lengths and provides a customizable writing environment for users.

### BRIEF DESCRIPTION OF THE DRAWINGS

FIG. 1 is a perspective-view illustrating the overall concept of a multi-functional pencil case according to an embodiment of the present invention.

FIG. 2 is a front-view illustration of FIG. 1.

FIG. 3 is an exploded perspective-view illustration of FIG. 1.

FIG. 4 is a view illustrating the state of adjusting the exposed length of the pencil in FIG. 2.

FIG. 5 is a front-view illustrating the touch pen mounted in place of the pencil in FIG. 2.

### DETAILED DESCRIPTION OF EXEMPLARY EMBODIMENTS

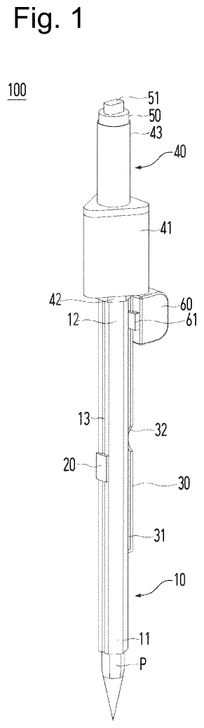

Referring to FIGS. 1 to 3, a multi-functional pencil case (100) according to an embodiment of the present invention may include a case body (10), a slide stopper (20), a slot-forming plate (30), an assembly tube (40), a touch pen (50), and an eraser (60).

The case body (10) forms the main body portion of the multi-functional pencil case (100) and is provided in a tubular shape with a hollow interior. One end (11) of the case body (10) is open to allow insertion and fixation of a pencil (P) or the touch pen (50) to be described later. The inner diameter of the case body (10) is formed to be approximately equal to or slightly larger than the standard diameter of a pencil (P), thereby allowing the pencil (P) to be inserted with ease. It is preferable that the case body (10) is configured with appropriate dimensional tolerances so that the inserted pencil (P) does not move excessively within the interior.

The material of the case body (10) is preferably lightweight while possessing sufficient rigidity and durability to allow for stable gripping by the user. For example, it may be manufactured using synthetic resins such as ABS (Acrylonitrile Butadiene Styrene), polycarbonate (PC), or polypropylene (PP) through an injection molding process, or may be produced by processing metal materials (e.g., aluminum alloy) or wood.

The surface of the case body (10) may be further provided with patterns or coatings for slip resistance.

In the present embodiment, the case body (10) may be formed with a hollow hexagonal cross-section structure. This hexagonal shape of the case body (10) provides an excellent grip feeling for the user, enhancing writing stability, and prevents the case (100) from rolling easily when placed on a flat surface such as a desk. Naturally, the cross-sectional shape of the case body (10) is not limited to a hexagon and may be modified into circular, rectangular, triangular, or ergonomically curved shapes depending on design purposes or user preferences.

A slide guide (13) is formed along the longitudinal direction on the outer circumferential surface of the case body (10). The slide guide (13) provides a guided path into which a slide stopper (20), described later, is movably coupled. In the present embodiment, the slide guide (13) may be implemented as a straight slot formed longitudinally along the case body (10).

The slide guide (13) may be formed along the entire length of the case body (10) or may be formed only in a specific section where pencil length adjustment is required.

The slide guide (13) may be provided in the form of a straight slot between a pair of parallel rails, and the slide stopper (20) may be configured to slide along the straight slot formed between the pair of rails.

The slide stopper (20) is movably coupled to the slide guide (13) of the case body (10), and functions to support and fix the rear end of the pencil (P) inserted into the one end (11) of the case body (10).

The user may push or pull the slide stopper (20) by hand to adjust its position along the case body (10), thereby effectively adjusting the length of the pencil (P) exposed to the outside according to its remaining length and securely fixing the pencil (P) to prevent it from wobbling or falling out from within the case body (10).

The slide stopper (20) includes a structure for engagement with the slide guide (13). For example, when the slide guide (13) is configured in the form of rails, the slide stopper (20) may have a groove structure that surrounds or fits between the rails to allow sliding movement.

In a preferred embodiment of the present invention, the slide stopper (20) may have an H-shaped or I-shaped cross-section. The slide stopper (20) may be formed in a plate shape comprising guide coupling portions on both sides, with one side inserted into the slide guide (13) and the opposite side exposed outward. These coupling portions may be connected by a central support plate (e.g., a straight plate shape), which is part of the slide stopper and configured to be inserted into the slide guide (13) and to slide along it. The central support plate directly supports the rear end of the pencil (P).

The H-shaped or I-shaped cross-sectional structure of the slide stopper (20) increases the contact area with the slide guide (13), thereby improving stability during movement, preventing twisting or disengagement during sliding operation, and providing uniform support to the rear end of the pencil, which enhances the reliability of fixation. Of course, the cross-sectional shape of the slide stopper (20) may be modified into other shapes such as T-shape or L-shape depending on the structure of the slide guide (13) and the required functionality.

The slide stopper (20) may include external protrusions, embossments, or anti-slip patterns to allow the user to easily push or pull it with a finger. In addition, it is preferable that an appropriate level of friction is applied between the slide stopper (20) and the slide guide (13), so that the stopper maintains its current position unless an intentional force is applied by the user. This can be further reinforced by incorporating a separate locking mechanism to secure the slide stopper (20) at specific positions. For example, a ratchet structure may be applied in which elastic projections are provided on the slide stopper (20) for pressing engagement, and a series of recesses are formed on the slide guide (13) so that the slide stopper (20) is caught at each recess. Alternatively, a frictional locking method using a screw or lever may also be employed.

The slide stopper (20) may be made of synthetic resin or metal having sufficient rigidity and wear resistance, similar to the case body (10). In consideration of sliding contact with the case body (10), it is advantageous to select a material with a low coefficient of friction or to apply a surface treatment.

The slot-forming plate (30) is provided on the outer surface of the case body (10) and serves as a structure for housing and fixing a straight ruler (R). Accordingly, students or professionals may insert and carry a thin, flat ruler (e.g., a plastic or metal ruler approximately 10 cm or 15 cm in length) in the slot-forming plate (30) for frequent use in writing or drafting work.

The slot-forming plate (30) may be integrally formed as a protrusion on the outer surface of the case body (10) or may be manufactured separately and then attached or coupled to the case body (10). In the present embodiment, it is assumed that the slot-forming plate (30) is formed as a panel protruding in the longitudinal direction along one face of the case body (10) (in the case of a hexagonal cross-section, along one flat side). On the inner side of the panel-shaped slot-forming plate (30), a straight slot (31) is formed so that a straight ruler (R) can be inserted and fixed. The width and depth of the slot (31) must be designed considering the thickness and width of the ruler (R) to be accommodated. It is important that the ruler (R), once inserted into the slot (31), is held in place by appropriate frictional or elastic force, so that it does not fall out easily but can be readily taken out by the user when needed. For example, small protrusions or elastic members may be provided on the inner wall of the slot (31) to securely hold the ruler (R) in place.

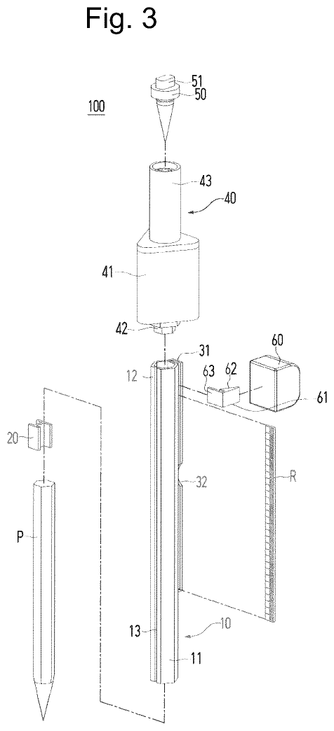

As shown in FIG. 3, a pull-out groove (32) may be formed in the middle portion of the slot-forming plate (30) to facilitate extracting the ruler (R) from the slot (31). The pull-out groove (32) may be formed as a concave portion of the slot-forming plate (30), enabling the user to push or lift a portion of the side or surface of the ruler (R) with a fingertip. Such a pull-out groove (32) is particularly useful when the ruler (R) is tightly inserted in the slot (31).

The position of the slot-forming plate (30) is determined in consideration of the cross-sectional shape of the case body (10) and the arrangement of other functional components. In a preferred embodiment of the present invention, when the case body (10) has a hexagonal cross-section, the slot-forming plate (30) may be positioned on the face opposite to the one where the slide guide (13) is formed. This arrangement is advantageous in terms of structural balance and efficient use of space. It also minimizes interference with the user's grip on the case (100) and enhances the overall symmetry and stability of the design.

The slot-forming plate (30) may generally be integrally molded from the same material as the case body (10) but may also be manufactured from a different material and then assembled, if necessary. For example, a different color or texture material may be used to adjust the frictional engagement with the ruler (R) or to provide a design accent.

The other end (12) of the case body (10) is the portion that is detachably coupled with the assembly tube (40), which will be described later. The coupling between the other end (12) of the case body (10) and the assembly tube (40) may be achieved by various means, such as screw coupling, interference fit, snap-fit coupling, or magnetic coupling. The assembly tube (40) is detachably coupled to the portion where the pencil is inserted into the pencil sharpener (41).

The assembly tube (40) is a component that is detachably assembled to the other end (12) of the case body (10) and primarily incorporates a pencil sharpener (41). Optionally, it also provides a space for storing additional tools such as the touch pen (50).

The assembly tube (40) may be configured to include: a case assembly portion (42) that couples with the case body (10); and a functional portion that includes the pencil sharpener (41) and/or a touch pen storage space (pen receiving portion (43)).

The case assembly portion (42) must be configured to correspond to the shape of the other end (12) of the case body (10). For example, if the case body (10) has a hollow hexagonal cross-section, the case assembly portion (42) must also have a matching hollow hexagonal cross-section (or outer profile) to enable stable coupling. As previously mentioned, the coupling method may be implemented in various ways such as screw coupling, interference fit, or snap fit. The detachable structure provides maintenance and usability advantages, such as allowing the user to empty shavings generated by use of the pencil sharpener (41), replace the blade, or take out the stored touch pen (50).

A pencil sharpener (41) is provided within the assembly tube (40). The pencil sharpener (41) has a structure similar to that of a typical portable pencil sharpener, including a blade for shaving the pencil lead and a conical guide hole into which the pencil is inserted. The user may use the pencil sharpener (41) by detaching the assembly tube (40) from the case body (10) while the pencil (P) is mounted, or by rotating the entire case with the assembly tube (40) attached. Shavings produced during sharpening may be temporarily stored within the internal space of the assembly tube (40), which can then be detached from the case body (10) and emptied. The blade of the pencil sharpener (41) may be designed to be replaceable when worn.

In an extended embodiment of the present invention, the assembly tube (40) may further include a pen receiving portion (43) for storing the touch pen (50), in addition to the pencil sharpening function of the pencil sharpener (41). The pen receiving portion (43) is an internal space designed to match the shape of the touch pen (50); for example, if the touch pen (50) is cylindrical, it may have a circular hollow cross-section. The touch pen (50) may be stored in the pen receiving portion (43) and taken out as needed, then inserted into the one end (11) of the case body (10) in place of the pencil (P). To that end, the diameter of the touch pen (50) must be designed to be compatible with the inner diameter of the one end (11) of the case body (10).

The pen receiving portion (43) is preferably configured to securely hold the touch pen (50) while allowing for easy attachment and detachment. For example, an elastic member may be installed internally to provide frictional resistance, or a snap-fit structure may be applied. Additionally, if the touch pen (50) is designed such that a portion of it—namely, the pen grip (51)—protrudes outward rather than being fully embedded in the pen receiving portion (43), the user can more easily grip and extract the pen. The pen grip (51) may correspond to the opposite end of the touch pen (50) from the functional terminal (namely, stylus tip or touch pen tip).

The assembly tube (40) may be made from synthetic resin or metal, similar to the case body (10), and the blade of the pencil sharpener is made of a highly wear-resistant metal.

Meanwhile, the touch pen (50) is a tool used for operating capacitive touchscreens, such as those of smartphones or tablet PCs, and is an optional component in the present invention. The touch pen (50) generally consists of a tip portion made from a conductive material and a body portion gripped by the user, including the pen grip (51).

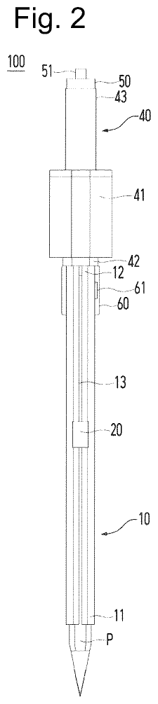

In the embodiment of the present invention, the touch pen (50) is normally stored within the pen receiving portion (43) of the assembly tube (40) (see FIGS. 1 and 2) and may be retrieved and inserted into the one end (11) of the case body (10) for use when operation of a touchscreen is required. That is, the pencil (P) and the touch pen (50) share the same interface—the one end (11) of the case body (10)—and are selectively attachable in a modular configuration. Accordingly, the body diameter of the touch pen (50) should be designed to be similar to the standard diameter of the pencil (P), so that it can be securely inserted into the one end (11) of the case body (10). A friction-enhancing structure or material (e.g., rubber ring) may be applied to the inner surface of the one end (11) of the case body (10) or to the surface of the touch pen (50) body to increase coupling stability.

The tip of the touch pen (50) may be made from a variety of materials, such as conductive fiber, silicone rubber, or conductive plastic. It is important that the tip provides a smooth writing feeling while preventing damage to the touchscreen. The pen grip (51) is formed from a material and in a shape that allows for comfortable gripping by the user and may be designed to facilitate easy removal from the pen receiving portion (43).

The eraser (60), which is a tool for erasing pencil marks, is an optional component in the present invention. As disclosed in FIG. 3 and claim 5, the eraser (60) may include a coupling plate (61) that allows it to be detachably coupled to the straight slot (31) of the slot-forming plate (30).

The coupling plate (61) may be attached to or integrally formed with a portion of the eraser (60) body and is designed in shape and size to be insertable and fixed within the straight slot (31) of the slot-forming plate (30). For example, the coupling plate (61) may be formed in a flat shape having a slope with a right-angled triangular tip (62), and a thickness and width similar to those of the ruler (R), to be easily inserted into the straight slot (31). This may serve as a slot-fixing portion (62). The user may carry the eraser (60) together with the ruler (R) inserted in the slot (31) and detach it for use when needed. Alternatively, a separate coupling structure exclusively for the eraser (60) may be provided at a specific location (e.g., an end portion) of the slot-forming plate (30). For instance, a small protrusion or groove may be formed at the end of the slot-forming plate (30), and a corresponding coupling structure may be formed on the eraser (60) or the coupling plate (61) so that it can be attached and detached using a snap-fit method.

The eraser (60) itself may be made of a general pencil eraser material (e.g., synthetic rubber), and the coupling plate (61) may be made of plastic, metal, or the like, considering its coupling strength with the eraser and its fixation stability within the slot (31).

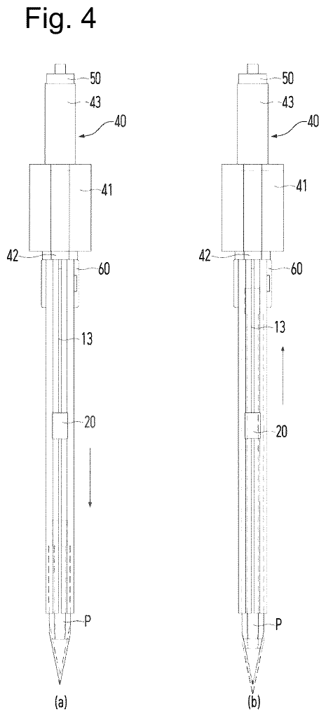

FIG. 4 illustrates the state in which the pencil (P) is mounted to the case body (10). The user inserts the stubby pencil (P) into the one end (11) of the case body (10). The slide stopper (20) is then moved along the longitudinal direction of the case body (10) to a position where it supports the rear end of the pencil (P), according to its length. The slide stopper (20) securely fixes the pencil (P) within the case body (10), allowing the user to hold the case body (10) and write as if using a full-length pencil. When the pencil lead wears down, the user may sharpen it using the pencil sharpener (41) by either detaching the assembly tube (40) or while it remains attached. If a ruler is needed during writing, the user may remove the ruler (R) from the slot (31) of the slot-forming plate (30). If an eraser is needed, the user may detach the eraser (60) or use it while it remains inserted in the slot (31).

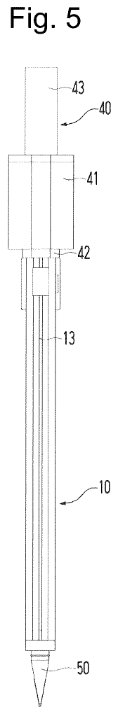

FIG. 5 illustrates the state in which the touch pen (50) is mounted to the case body (10). When operation of a touchscreen is required, the user removes the touch pen (50) from the pen receiving portion (43) of the assembly tube (40). If a pencil (P) is already inserted into the case body (10), it is first removed, and the touch pen (50) is then inserted into the one end (11) of the case body (10). The user may then hold the case body (10) and operate the touchscreen using the touch pen (50). Once finished, the user removes the touch pen (50) and returns it to the pen receiving portion (43), and if necessary, reinstalls the pencil (P).

The embodiments described above are merely illustrative examples intended to aid in understanding the present invention, and the technical spirit of the invention may be modified and expanded in various forms.

The shape of the case body is not limited to a hexagonal cross-section and may instead adopt various other cross-sectional shapes such as circular, rectangular, elliptical, or ergonomically curved profiles. Additional features such as rubber grips or surface patterns may also be added to enhance the user's grip comfort.

The fixation method of the slide stopper is not limited to frictional retention and may incorporate various locking mechanisms such as ratchet structures, screw fixations, or lever-type clamps. A gear-based mechanism for fine adjustment of the stopper position may also be introduced.

The coupling method for the ruler and eraser is not limited to slot insertion, and may include magnetic coupling, clip-based attachment, or a rotary storage structure. A combined slot structure capable of simultaneously housing both a ruler and an eraser may also be applied. Furthermore, the ruler scale may be printed or engraved directly onto the surface of the case body.

In terms of functional expansion of the assembly tube, additional modules such as a mini stapler, hole puncher, USB memory stick, laser pointer, or LED light may be embedded or made interchangeable, in addition to the pencil sharpener. Design improvements may also be considered to facilitate the disposal of pencil shavings.

Regarding the expansion of touch pen functionality, it is possible to apply a touch pen module with pressure sensitivity (active stylus) in addition to a general capacitive touch pen. A structure enabling replacement of the stylus tip may also be added.

From the perspective of material diversification, the present invention may employ not only plastics, metals, and wood, but also eco-friendly or high-performance materials such as carbon fiber and bioplastics. Transparent material may also be used to allow the user to check the remaining length of the pencil or the mount of shavings inside the pencil sharpener.

As an additional feature of the present invention, a clip may be attached to the case body or the assembly tube to allow the case to be fastened to a clothing pocket or notebook. A strap hole may also be provided to attach a portable carrying strap.

Such various modifications and extensions may be made while maintaining the basic technical concept of the present invention—namely, the utilization of stubby pencils and the integration of multi-functional tools—and all such variations shall be construed as falling within the scope of the present invention.

What is claimed is:

1. A multi-functional pencil case comprising:
a tubular case body having a slide guide formed along a longitudinal direction thereof, wherein a pencil is inserted and fixed at one end of the tubular case body;
a slide stopper movably engaged with the slide guide and configured to move according to the length of the pencil;
a slot-forming plate provided on an outer surface of the tubular case body, and having a straight slot in which a flat ruler is received and fixed;
an assembly tube detachably coupled to the other end of the tubular case body, and provided with a pencil sharpener.

2. The multi-functional pencil case of claim 1, further comprising:
a touch pen configured to be inserted into the one end of the tubular case body in place of the pencil, and being removably stored and fixed in the assembly tube.

3. The multi-functional pencil case of claim 2, wherein the tubular case body has a hollow hexagonal cross-section structure, and the slide guide and the slot-forming plate are positioned on opposite faces of a hexagonal structure.

4. The multi-functional pencil case of claim 3, wherein the assembly tube comprises:
a case assembly portion having a hollow hexagonal cross-section structure configured to be assembled with the tubular case body; and
a pen receiving portion having a hollow circular cross-section structure configured to receive the touch pen,
wherein the touch pen is partially inserted into the pen receiving portion such that a pen grip protrudes outward.

5. The multi-functional pencil case of claim 1, further comprising:
an eraser having a coupling plate that is detachably coupled to the straight slot at one end of the slot-forming plate.

6. The multi-functional pencil case of claim 1, wherein the slide stopper has an H-shaped cross-section, with a middle portion formed in the shape of a flat plate, to be slidable along the slide guide of the tubular case body.

7. The multi-functional pencil case of claim 1, wherein a pull-out groove for extracting the flat ruler is formed in a middle portion of the slot-forming plate.
